(19) United States
(12) Patent Application Publication
(10) Pub. No.: US 2013/0147353 A1
(43) Pub. Date: Jun. 13, 2013

(54) LIGHT SOURCE PACKAGE

(71) Applicants: David Mandelboum, Rakefet (IL); Asaf Pellman, Rishpon (IL); Giora Yahav, Haifa (IL)

(72) Inventors: David Mandelboum, Rakefet (IL); Asaf Pellman, Rishpon (IL); Giora Yahav, Haifa (IL)

(73) Assignee: MICROSOFT CORPORATION, Redmond, WA (US)

(21) Appl. No.: 13/323,658

(22) Filed: Dec. 12, 2011

(51) Int. Cl. H05B 37/02

(52) U.S. Cl. 315/119

(57) ABSTRACT

A light source package for selectively interrupting power to a light source is provided. An optical element is positioned to reflect a reflected portion of the light from the light source. The reflected portion impinges upon a base that includes a roof panel with a light source side and a sensor side that is opposite to the light source side. The light source side of the roof panel receives the reflected portion of the light and transmits a transmitted portion of the light through the roof panel. The sensor side of the roof panel includes a recess in which a sensing component is located. The sensing component receives the transmitted portion of the light and is be configured to interrupt power to the light source when the transmitted portion of the light is below a threshold.

### BACKGROUND

Semiconductor light sources may be packaged in a variety of packaging configurations. Depending upon the type and intensity of the light source, one consideration in light source package design may be inhibiting stray light from exiting the light source package. One approach to addressing this consideration may include providing a separate mechanism in the light source package for interrupting power to the light source upon damage to or dismantling of the packaging.

In some previous light source packages, as long as a mechanical connection between parts of the package remains intact, a conductive path from a power source to the light source is maintained. If the mechanical connection is broken or dislodged, such as if the light source package is damaged or dismantled, the power source is disconnected from the light source. In this manner, a possibility of stray light exiting the light source package may be lessened. In one example, a light source package may use a safety switch that is external to the package to disconnect power from the light source if the light source package is damaged.

One drawback with using mechanical connections such as external safety switches is that the additional connections and componentry reduce the space available for other components, while increasing the overall size and footprint of the light source package. Particularly in smaller electronic devices, reducing the size and footprint of a light source package may be desirable.

### SUMMARY

To address the above considerations, a light source package and related method for selectively interrupting power to a light source are provided. In one example, the light source package may include a low inductance connector on which a light source is mounted. An optical element may be positioned opposite to an emitting side of the light source to receive source light propagating from the emitting side of the light source. The optical element may reflect a reflected portion of the source light it receives.

The light source package may include a base that is positioned opposite to a non-emitting side of the light source that is opposite to the emitting side of the light source. The base comprises a roof panel that includes a light source side and a sensor side that is opposite to the light source side. The light source side of the roof panel may receive the reflected portion of the source light, and the sensor side of the roof panel may include a recess. A sensing component may be positioned within the recess of the sensor side of the roof panel, with the sensing component receiving a transmitted portion of the reflected portion of the source light that is transmitted through the roof panel. The sensing component may be configured to interrupt power to the light source when the transmitted portion of the source light is below a threshold.

### BRIEF DESCRIPTION OF THE DRAWINGS

FIG. 1 shows a schematic view of a light source package according to one embodiment of the present disclosure.

FIG. 2 shows a bottom view of the light source package of FIG. 1.

FIG. 3 is a simplified schematic illustration of an embodiment of a computing device and a light source package.

FIG. 4 shows a flow chart of a method for selectively interrupting power to a light source in a light source package according to one embodiment of the present disclosure.

### DETAILED DESCRIPTION

FIG. 1 shows a schematic view of a light source package 10 for housing a light source 14 and selectively interrupting power to the light source according to one embodiment of the present disclosure. The light source 14 may comprise a semiconductor light source. Examples of semiconductor light sources include, but are not limited to, laser diodes, vertical-cavity surface-emitting lasers (VCSELs) and light-emitting diodes (LEDs).

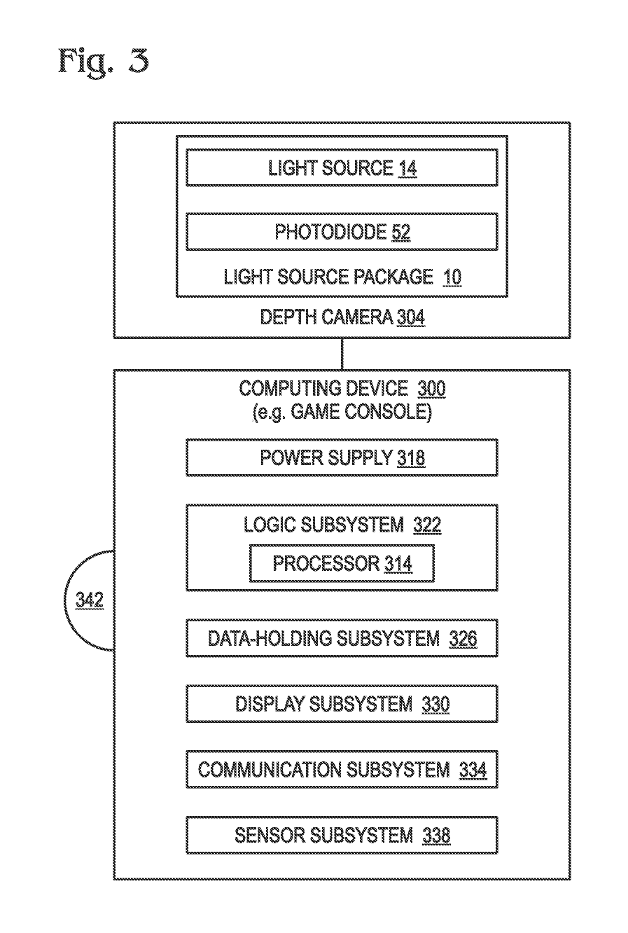

It will be appreciated that the light source package 10 and light source 14 may be used in a diverse array of applications related to illumination. Such applications include, but are not limited to, gaming systems, machine vision systems, display devices, lighting systems, control systems, and indicators. In some examples, the light source package 10 and light source 14 may be used in gaming systems that receive user movements as inputs. In a more specific example, and as schematically illustrated in FIG. 3, the light source package 10 and light source 14 may be used in a depth camera 304 that provides depth information to a computing device 300 in the form of a game console. Examples of depth cameras and additional details regarding the computing aspects of the computing device 300 are described in more detail below. It will also be appreciated that the light source 14 may generate light of any suitable wavelength (e.g., one or more wavelengths in an infrared, near infrared, visible, and/or ultraviolet region).

The light source 14 may be mounted to a low inductance connector 18. In the example illustrated in FIG. 1, the low inductance connector 18 may comprise a central conductor 22 that is positioned between a first side conductor 26 and a second side conductor 30. The light source 14 may be bonded to the central conductor 22 using a conductive material such as adhesive, epoxy or solder such that a light source cathode (not shown) is electrically connected to the central conductor. A light source anode (not shown) may be electrically connected to the first side conductor 26 by bonding wires 34. Similarly, the light source anode may be electrically connected to the second side conductor 30 by bonding wires 36.

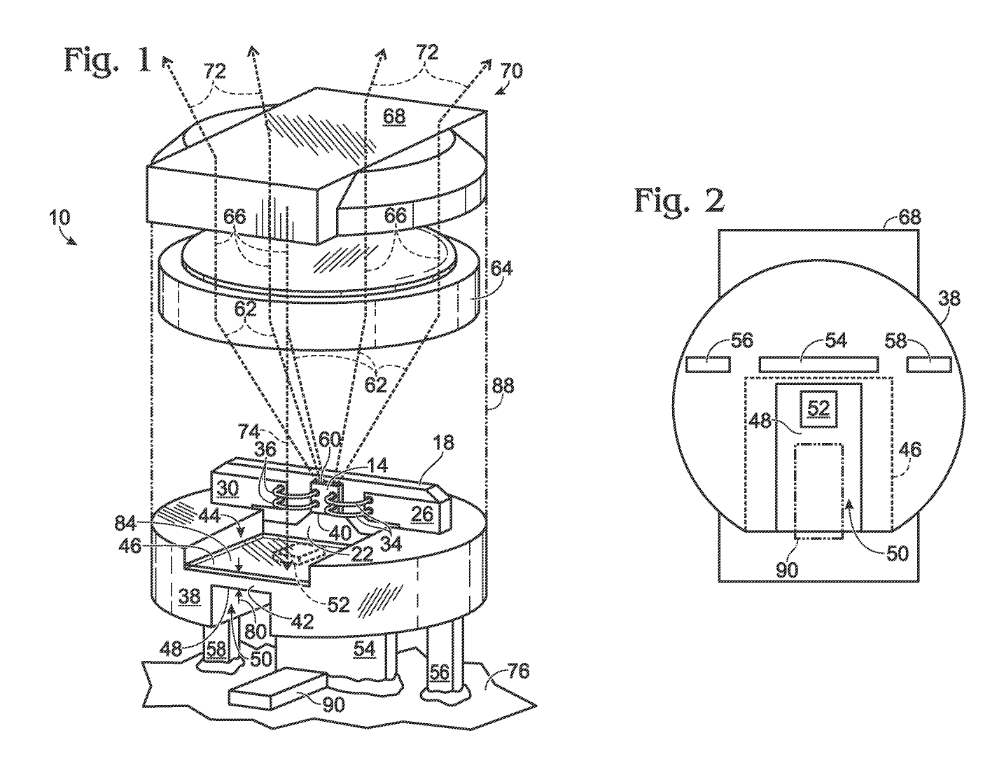

The low inductance connector 18 may be potted in a base 38 comprising an insulating material, such as a transparent polymer or other suitable material. As shown in FIG. 1, the base 38 may be positioned opposite to a non-emitting side 40 of the light source 14. The base 38 includes a roof panel 42 formed in an upper recess 44 of the base. The roof panel 42 includes a light source side 46 and a sensor side 48 that is opposite to and underneath the light source side. With reference also to FIG. 2, the sensor side 48 of the roof panel 42 includes a lower recess 50 in which a sensing component 52 is positioned As explained in more detail below, the sensing component 52 may receive a portion of light emitted from the light source 14 that is reflected and transmitted through the roof panel 42. Additionally, the lower recess 50 creates additional packaging space that may allow one or more additional electronic components to be located under the footprint and/or adjacent to the light source package 10.

With reference again to FIG. 1, a central conductor extension 54, first side conductor extension 56, and second side conductor extension 58 each extend from the base 38 and function as electrical connectors for supplying power to the light source 14 from a power source. In one example and as shown schematically in FIG. 1, the central conductor extension 54, first side conductor extension 56, and second side conductor extension 58 may be soldered to pads on a printed circuit board 76. It will be appreciated that the lengths of central conductor extension 54, first side conductor extension 56, and second side conductor extension 58 may be shorter than as shown in FIG. 1, such that the base 38 is positioned closer or adjacent to the printed circuit board 76.

It will also be appreciated that the central conductor extension 54, first side conductor extension 56, and second side conductor extension 58 may be electrically connected to a power source via the printed circuit board 76. In other examples, the central conductor extension 54, first side conductor extension 56, and second side conductor extension 58 may be electrically connected to a power source via insertion into an electrical socket, or by any other suitable means.

With continued reference to FIG. 1, the printed circuit board 76 may also include one or more additional electronic components under the footprint of and/or adjacent to the light source package 10. As schematically illustrated in FIGS. 1 and 2, in one example the printed circuit board 76 may include an additional electronic component 90 that is positioned to fit within the lower recess 50 of the sensor side 48 of the roof panel 42. The additional electronic component 90 may take the form of, for example, a transistor, a resistor, or any other suitable electronic component. In this manner, the lower recess 50 may create additional packaging space that allows one or more components on the printed circuit board 76 to be located under the footprint of the light source package 10.

Furthermore, because the sensing component 52 may be located within the footprint of the light source package 10, as opposed to outside the footprint of the package, additional space on the printed circuit board 76 adjacent to the light source package 10 may be available for other components. It will also be appreciated that the lower recess 50 and/or upper recess 44 may have other shapes and configurations, such as circular, oval, triangular, or any other suitable combination of straight and/or rounded sides. Additionally, the availability of additional packaging space under and/or adjacent to the footprint of the light source package 10 may enable the use of standard, off-the-shelf photodiodes and other components, thereby facilitating easy component replacements and lower costs. For example, components that fit within the lower recess 50 may be used.

With reference again to FIG. 1, the light source 14 includes an emitting side 60 from which emitted source light rays 62 propagate toward a first optical element 64. In one example, the first optical element 64 may take the form of a collimator that receives and collimates the emitted source light rays 62 to create collimated source light rays 66. The collimated source light rays 66 travel from the first optical element 64 to a second optical element 68 positioned at a distal end 70 of the light source package 10.

The second optical element 68 may receive the collimated source light rays 66 and pass an illuminating portion, illustrated as illuminating rays 72, of the collimated source light rays beyond the light source package 10. Additionally, the second optical element 68 may reflect a reflected portion, illustrated as reflected ray 74, of the collimated source light rays 66 toward base 38. In one example, the second optical element 68 may take the form of a refractive diffuser that receives and diffuses the illuminating portion of the collimated source light rays 66.

Reflected ray 74 may impinge upon the light source side 46 of the roof panel 42. As noted above, the base 38 and roof panel 42 may be formed from a transparent polymer. In this manner, the roof panel 42 may permit the reflected ray 74 to pass through the roof panel and impinge upon the sensing component 52 in the recess 50. Alternatively expressed, the sensing component 52 may receive a transmitted portion of the reflected ray 74 that is transmitted through the roof panel 42.

With reference now to FIGS. 2 and 3, the sensing component 52 may comprise a photodiode 52. Example materials of the photodiode 52 include, but are not limited to, silicon, germanium, and indium gallium arsenide. In one example, the photodiode 52 may be electrically connected to a circuit that includes a processor 314 and a power supply 318 that supplies power to the light source 14.

In one example, the processor 314 may receive an output signal from the photodiode 52 and determine whether the output signal meets or exceeds a threshold output signal that corresponds to a threshold portion of transmitted source light reaching the photodiode. The threshold portion of transmitted source light reaching the photodiode may correspond to the second optical element 68 properly reflecting a reflected portion of the source light to the roof panel 42. This, in turn, may correlate to the light source package being intact and operating properly. Thus, if the output signal meets or exceeds the threshold output signal, then the processor may control the power supply 318 to provide power to the light source 14.

On the other hand, if the output signal is below the threshold output signal, then the processor may control the power supply to interrupt power to the light source 14. In this manner, if the light source package 10 is damaged, disassembled, or otherwise compromised such that sufficient reflected rays 74 do not reach the photodiode 52, the power to the light source 14 is interrupted to prevent stray source light rays 62 from escaping the light source package.

In another example, the processor 314 may monitor the output signal from the photodiode 52 to assess a calibration and/or performance of the light source 14. For example, a weak or inconsistent output signal may indicate that the light source 14 may need repair, replacement, or current adjustment.

It will be appreciated that a sensitivity of the photodiode 52 may be adjusted to match the optical characteristics of the light source 14, the first optical element 64, the second optical element 68, and/or the roof panel 42. Such optical characteristics include, but are not limited to, transparency, translucency, opacity, and reflectivity. Similarly, a thickness 80, shape and/or material property of the roof panel 42 may be adjusted or modified to correspond to the sensitivity of the photodiode 52. More specifically, the amount and/or wavelength of the reflected rays 74 that are passed through the roof panel 42 to the photodiode 52 may be controlled by adjusting or modifying the thickness 80, shape and/or material properties of the roof panel.

In one example, light-absorbing pigments and/or other materials may be mixed into the plastic or other polymer composition of the roof panel 42 and base 38. In another example, a separate filter 84 may be provided on the light source side 46 of the roof panel 42 to filter one or more wavelengths of the reflected rays 74 that are received at the roof panel. For example, the filter may be transparent to infrared light but may substantially block visible light. It will be appreciated that the filter 84 may comprise a coating, film, discrete substrate, or other suitable material. In this manner, the structure and composition of the roof panel 42 may be tuned to correspond to a desired strength and/or sensitivity of the photodiode 52. Accordingly, this may enable the use of a variety of photodiodes, including less accurate and/or less expensive photodiodes.

In another example, the roof panel 42 may be configured to focus the reflected rays 74 toward the photodiode 52 or to diffuse the reflected rays 74. More specifically, a shape of the roof panel 42 and/or material properties of the roof panel may be adjusted or modified to focus or diffuse the reflected rays 74.

It will also be appreciated that components other than a photodiode 52 may be located in the lower recess 50 and/or upper recess 44 of the roof panel 42. Such other components may include, for example, a current-backflow-prevention diode. Advantageously, positioning a current-backflow-prevention diode near the light source 14 in the lower recess 50 or upper recess 44 may reduce a length of connecting wire between the diode and the light source, thereby reducing inductance. In other examples, two or more components may be located in the upper recess 44 and/or lower recess 50.

Additionally, and with reference to FIG. 1, it will be appreciated that a lens tube 88 may house the light source package 10 including the low inductance connector 18, first optical element 64, second optical element 68, base 38, light source 14 and sensing component 52.

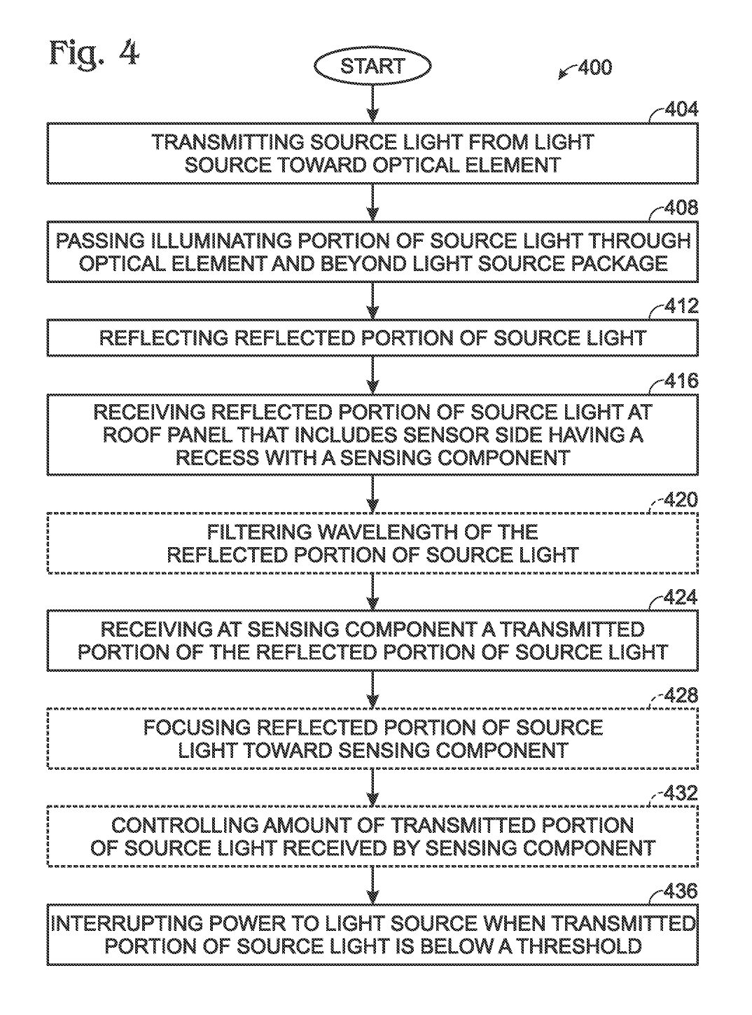

FIG. 4 illustrates a flow chart of a method 400 for selectively interrupting power to a light source mounted on a low inductance connector in a light source package according to one embodiment of the present disclosure. The following description of method 400 is provided with reference to the components of light source package 10 described above and shown in FIGS. 1-3. It will be appreciated that method 400 may also be performed in other contexts using other suitable hardware and software components.

At 404 the method may include transmitting source light from an emitting side 60 of the light source 14 toward the second optical element 68 positioned opposite to the emitting side of the light source. At 408 the method may include passing an illuminating portion of the source light through the second optical element 68 and beyond the light source package 10. At 412 the method may include reflecting a reflected portion of the source light, such as reflected ray 74.

At 416 the method may include receiving the reflected portion of the source light at the light source side 46 of the roof panel 42. As noted above, the roof panel 42 also includes a sensor side 48 having a lower recess 50 in which the sensing component 52 is located. At 420 the method 400 may optionally include filtering one or more wavelengths of the reflected portion of the source light.

At 424 the method may include receiving at the sensing component 52 a transmitted portion of the reflected portion of source light. In one example, at 428 the method may optionally include focusing the reflected portion of the source light toward the sensing component 52. In another example, at 432 the method may include controlling an amount of the transmitted portion of the source light that is received by the sensing component 52 by modifying one or more of a shape, thickness, and material property of the roof panel, as described above. At 436, the method may include interrupting power to the light source 14 when the transmitted portion of the source light is below a threshold.

FIG. 3 schematically illustrates a nonlimiting embodiment of a computing device 300, such as a game console, that may perform one or more of the above described methods and processes. Computing device 300 is shown in simplified form. It is to be understood that virtually any computer architecture may be used without departing from the scope of this disclosure. In different embodiments, computing device 300 may take the form of a desktop computing device, a mobile computing device such as a laptop, notebook or tablet computer, network computer, home entertainment computer, interactive television, game console, etc. Further, in some embodiments the methods and processes described herein may be implemented as a computer application, computer service, computer API, computer library, and/or other computer program product in a computing system that includes one or more computers.

As shown in FIG. 3, computing device 300 includes a power supply 318, a logic subsystem 322, a data-holding subsystem 326, a display subsystem 330, a communication subsystem 334, and a sensor subsystem 338. Computing device 300 may optionally include other subsystems and components not shown in FIG. 3.

Logic subsystem 322 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 322 may include one or more processors, such as processor 314, that are configured to execute software instructions. Additionally or alternatively, the logic subsystem 322 may include one or more hardware or firmware logic machines configured to execute hardware or firmware instructions. Processors of the logic subsystem 322 may be single core or multicore, and the programs executed thereon may be configured for parallel or distributed processing. Processors may optionally include individual components that are distributed throughout two or more devices that may be remotely located and/or configured for coordinated processing. One or more aspects of the processors may be virtualized and executed by remotely accessible networked computing devices configured in a cloud computing configuration.

Data-holding subsystem 326 may include one or more physical, non-transitory devices configured to hold data and/or instructions executable by the logic subsystem 322 to implement the methods and processes described herein. When such methods and processes are implemented, the state of data-holding subsystem 326 may be transformed (e.g., to hold different data).

Data-holding subsystem 326 may include removable media and/or built-in devices. Data-holding subsystem 326 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 326 may include devices with one or more of the following characteristics: volatile, nonvolatile, dynamic, static, read/write, read-only, random access, sequential access, location addressable, file addressable, and content addressable. In some embodiments, logic subsystem 322 and data-holding subsystem 326 may be integrated into one or more common devices, such as an application specific integrated circuit or a system on a chip.

FIG. 3 also shows an aspect of the data-holding subsystem 326 in the form of removable computer-readable storage media 342, which may be used to store and/or transfer data and/or instructions executable to implement the methods and processes described herein. Removable computer-readable storage media 342 may take the form of CDs, DVDs, HD-DVDs, Blu-Ray Discs, EEPROMs, and/or floppy disks, among others.

It is to be appreciated that data-holding subsystem 326 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

Display subsystem 330 includes one or more image display systems configured to present a visual representation of data held by data-holding subsystem 326. As the methods and processes described herein change the data held by the data-holding subsystem 326, and thus transform the state of the data-holding subsystem, the state of display subsystem 330 may likewise be transformed to visually represent changes in the underlying data.

Communication subsystem 334 may be configured to communicatively couple computing device 300 with one or more networks and/or one or more other computing devices. Communication subsystem 334 may include wired and/or wireless communication devices compatible with one or more different communication protocols. As nonlimiting examples, communication subsystem 334 may be configured for communication via a wireless telephone network, a wireless local area network, a wired local area network, a wireless wide area network, a wired wide area network, etc. In some embodiments, communication subsystem 334 may allow computing device 300 to send and/or receive messages to and/or from other devices via a network such as the Internet.

Sensor subsystem 338 may include one or more sensors configured to sense one or more user movements as inputs. As noted above, in some embodiments the sensor subsystem 338 may include a depth camera 304 that includes light source package 10. In one example, depth camera 304 may be a time-of-flight camera configured to project a pulsed infrared illumination from the light source 14 onto a scene. The depth camera may include one or two cameras configured to detect the pulsed illumination reflected from the scene. Each camera may include an electronic shutter synchronized to the pulsed illumination, but the integration times for the cameras may differ, such that a pixel-resolved time-of-flight of the pulsed illumination, from the source to the scene and then to the cameras, is discernable from the relative amounts of light received in corresponding pixels of the two cameras.

In other examples, depth camera 304 may be a structured light depth camera configured to project structured infrared illumination comprising numerous, discrete features (e.g., lines or dots) from the light source 14. Depth camera 304 may be configured to image the structured illumination reflected from a scene onto which the structured illumination is projected. Based on the spacings between adjacent features in the various regions of the imaged scene, a depth image of the scene may be constructed.

In other examples, depth camera 304 may include left and right cameras of a stereoscopic vision system. Time-resolved images from both cameras may be registered to each other and combined to yield depth-resolved video

In other examples, sensor subsystem 338 may include a visible light camera. Virtually any type of digital camera technology may be used without departing from the scope of this disclosure. As a non-limiting example, a visible light camera may include a charge coupled device image sensor.

It will also be appreciated that computing device 300 may optionally receive inputs from other user input devices including, but not limited to, keyboards, mice, game controllers, cameras, microphones, and/or touch screens.

The terms “module,” “program,” and “engine” may be used to describe an aspect of computing device 300 that is implemented to perform one or more particular functions. In some cases, such a module, program, or engine may be instantiated via logic subsystem 322 executing instructions held by data-holding subsystem 326. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A light source package for housing a light source and selectively interrupting power to the light source, the light source package comprising:
a low inductance connector on which the light source is mounted;
an optical element positioned opposite to an emitting side of the light source to receive source light propagating from the emitting side of the light source, the optical element reflecting a reflected portion of the source light;
a base positioned opposite to a non-emitting side of the light source that is opposite to the emitting side of the light source, the base comprising a roof panel that includes a light source side and a sensor side that is opposite to the light source side, the light source side receiving the reflected portion of the source light, the sensor side including a recess; and
a sensing component positioned within the recess of the sensor side of the roof panel, the sensing component receiving a transmitted portion of the reflected portion of the source light that is transmitted through the roof panel, the sensing component configured to interrupt power to the light source when the transmitted portion of the source light is below a threshold.

2. The light source package of claim 1, wherein the sensing component is a photodiode.

3. The light source package of claim 1, wherein the optical element passes an illuminating portion of the source light beyond the light source package.

4. The light source package of claim 3, wherein the optical element comprises a diffusing lens.

5. The light source package of claim 1, wherein the base comprises an insulating material, and the low inductance connector is potted in the base.

6. The light source package of claim 5, wherein the low inductance connector comprises a central conductor to which the light source is electrically connected, and at least one side conductor to which the light source is electrically connected.

7. The light source package of claim 6, wherein the central conductor further comprises a central conductor extension that extends from the base, the at least one side conductor comprises a side conductor extension that extends from the base, and the central conductor extension and the side conductor extension electrically connect the light source to a power supply.

8. The light source package of claim 1, wherein the roof panel comprises a thickness that corresponds to a sensitivity of the sensing component.

9. The light source package of claim 1, wherein the roof panel comprises a filter element that filters a wavelength of the reflected portion of the source light received at the light source side of the roof panel.

10. The light source package of claim 1, further comprising a lens tube that houses at least the low inductance connector, the optical element, the base, and the sensing component.

11. The light source package of claim 1, wherein the optical element is a first optical element, further comprising a second optical element positioned between the first optical element and the light source.

12. A method for selectively interrupting power to a light source mounted on a low inductance connector in a light source package, comprising:
transmitting source light from an emitting side of the light source toward an optical element positioned opposite to the emitting side of the light source;
reflecting a reflected portion of the source light;
receiving the reflected portion of the source light at a light source side of a roof panel, the roof panel including a sensor side having a recess that is opposite to the light source side, the roof panel embodied in a base that is positioned opposite to a non-emitting side of the light source that is opposite to the emitting side of the light source;
receiving at a sensing component a transmitted portion of the reflected portion of the source light that is transmitted through the roof panel, the sensing component positioned within the recess of the sensor side of the roof panel; and
interrupting power to the light source when the transmitted portion of the source light is below a threshold.

13. The method of claim 12, further comprising passing an illuminating portion of the source light through the optical element and beyond the light source package.

14. The method of claim 12, further comprising filtering a wavelength of the reflected portion of the source light received at the light source side of the roof panel.

15. The method of claim 12, further comprising focusing the reflected portion of the source light toward the sensing component.

16. The method of claim 12, wherein the sensing component is a photodiode.

17. The method of claim 12, wherein the base comprises an insulating material.

18. The method of claim 12, further comprising controlling an amount of the transmitted portion of the reflected portion of the source light that is received by the sensing component by modifying one or more of a shape, thickness, and material property of the roof panel.

19. A light source package for housing a light source and selectively interrupting power to the light source, the light source package comprising:
a low inductance connector on which the light source is mounted;
an optical element positioned opposite to an emitting side of the light source to receive source light propagating from the emitting side of the light source, the optical element reflecting a reflected portion of the source light and passing an illuminating portion of the source light beyond the light source package;
a base positioned opposite to a non-emitting side of the light source that is opposite to the emitting side of the light source, the base comprising a roof panel that includes a light source side and a sensor side that is opposite to the light source side, the light source side receiving the reflected portion of the source light, the sensor side including a recess;
a photodiode positioned within the recess of the sensor side of the roof panel, the photodiode receiving a transmitted portion of the reflected portion of the source light that is transmitted through the roof panel, the photodiode configured to interrupt power to the light source when the transmitted portion of the source light is below a threshold; and
a lens tube housing at least the low inductance connector, the optical element, the base, and the photodiode.

20. The light source package of claim 19, wherein the base comprises an insulating material, and the low inductance connector is potted in the base and comprises a central conductor to which the light source is electrically connected and at least one side conductor to which the light source is electrically connected.
